(19) United States
(12) Patent Application Publication
(10) Pub. No.: US 2017/0101171 A1
(43) Pub. Date: Apr. 13, 2017

(54) ROLLING BEARING FOR BLADE ROOT, OSCILLATING SYSTEM, AND ROTATING SYSTEM

(71) Applicant: NTN-SNR ROULEMENTS, Annecy (FR)

(72) Inventor: Guillaume LEFORT, ANNECY (FR)

(21) Appl. No.: 15/287,389

(22) Filed: Oct. 6, 2016

(30) Foreign Application Priority Data
Oct. 9, 2015 (FR) 15 59612

(51) Int. Cl. B64C 11/32; B64C 11/06; F04D 29/059; F04D 29/38; F04D 29/36

(52) U.S. Cl. CPC B64C 11/325; F04D 29/38; F04D 29/362; F04D 29/059; B64C 11/06

(57) ABSTRACT

A blade root extends in a longitudinal direction between a proximal end and a distal end. The rolling bearing allows oscillation of the root about an axis extending in the longitudinal direction relative to a housing. The rolling bearing includes a single outer ring, a first inner ring providing a distal seat, a second inner ring fitted onto the seat and held in axial abutment against the first inner ring. The inner surface of the first inner ring includes a shoulder for assembly to a blade root. The outer surface of the single outer ring includes a shoulder for assembly to a housing.

### FIELD OF THE INVENTION

The invention relates to the field of rolling bearings for blade roots.

More specifically, the invention relates to the field of blades with variable angle of attack in a rotating housing of an aircraft propeller, or other applications.

### BACKGROUND TO THE INVENTION

GB 2,251,896 describes an example of a rolling bearing having a complex architecture with many parts assembled together, which causes problems in achieving an effective seal. In addition, this product has a large footprint, and must be assembled by the end user directly onto the shaft. There are many risks related to this assembly by the end user where there can be incorrect mounting, including the risk of incorrectly applying the preload, leading to premature failure of these bearings.

FR 2,862,609 describes an example of such a product where the blade is assembled in a housing (called a “hub” in that document) by one of its ends, called the blade root. The root is mounted so as to pivot about an axis substantially perpendicular to and intersecting with the rotor axis in a chamber of the housing. This pivoting, driven by a device (not shown) coupled to an extension of a cap on the root, allows adjusting the angle of attack of the blade.

The chamber comprises a stepped side wall, rotationally symmetrical about a radial axis of the propeller which, after installation of the blade, is substantially coincident with the axis of the blade. An inner side of the chamber opens toward the center of the propeller and an outer side opens toward the blade (in that document, and in that context, the terms “inner side and outer side” refer to the location along the radial axis of the propeller).

First and second rows of angular contact rolling elements are mounted between a skirt surrounding the root, and a respective cup and outer ring mounted on the side wall, in a conventional “O” assembly.

The rolling elements, arranged near the outer and inner sides respectively, are tapered rollers and angular contact ball bearings respectively. Each roller has its wide base facing outward.

The cup and the outer ring are supported on the wall by means of plastic protective parts. The outer ring on the inner side is supported on a first shoulder of the hub, preventing it from axial outward movement (in that document, in that context, the terms “inward” and “outward” are used conventionally to describe a bearing, designating the radial location relative to an axis of the bearing).

Inner races for the rollers and ball bearings are respectively formed in the protective skirt.

When the propeller rotates, the blade undergoes two actions:
an axial or centrifugal force for the blade and the rolling bearing that is a function of its speed and mass,
a bending moment at the blade root due to radial force on the blade resulting from the interaction between the blade and the air it is moving.

To effectively withstand these actions, the rolling bearings are preloaded, in other words a compression of their rolling elements between their races is created and maintained.

While this implementation is entirely satisfactory, there is always a search for ways to improve the performance of these products, maximizing the forces they can withstand while minimizing their footprint.

This search has led to entirely redesigning the architecture of rolling bearings for blade roots.

### SUMMARY OF THE INVENTION

A description of the invention is given below.

According to a first aspect, the invention relates to a rolling bearing for a blade root extending in a longitudinal direction between a proximal end and a distal end, the rolling bearing allowing oscillation of the root about an axis extending in the longitudinal direction relative to a housing, the rolling bearing comprising:
a single outer ring having an inner surface and an outer surface opposite to the inner surface, the inner surface of the outer ring having a proximal first outer race and a distal second outer race, the first and second outer races being offset relative to one another in the longitudinal direction,
a first inner ring having an inner surface and an outer surface opposite to the inner surface, the outer surface of the first inner ring having a proximal first inner race and a distal seat, the first inner race and the seat being offset relative to one another in the longitudinal direction,
a second inner ring having an inner surface and an outer surface opposite to the inner surface, the outer surface of the second inner ring having a distal second inner race, the second inner ring being fitted onto the seat and being held in axial abutment against the first inner ring,
a single inner space being defined between the inner surface of the outer ring and the outer surface of the first and second inner rings, the single inner space extending between a proximal end where it is sealed by a proximal sealing system between the outer ring and the first inner ring and a distal end where it is sealed by a distal sealing system between the outer ring and the second inner ring,
a proximal first row of rolling elements mounted in the single inner space, rolling on the proximal first inner and outer races, and a distal second row of rolling elements mounted in the single inner space, rolling on the distal second outer and inner races, the first and second rows of rolling elements being spaced apart from each other along the longitudinal axis,
the inner surface of the first inner ring comprising a shoulder for assembly to a blade root,
the outer surface of the single outer ring comprising a shoulder for assembly to a housing.

In one embodiment, the shoulder for assembly provided on the outer surface of the single outer ring is arranged axially between the first and second rows of rolling elements.

In one embodiment, the shoulder for assembly provided on the inner surface of the first inner ring is arranged more proximally than the proximal first row of rolling elements.

In one embodiment, the rolling bearing further comprises a loading system adapted to hold the second inner ring in axial abutment against the first inner ring.

In one embodiment, the loading system comprises an annular plate having a bearing surface in contact with the second inner ring and urging the second inner ring in the axial direction, the annular plate being held secured to the first inner ring by screwing.

In one embodiment, the distance, normal to the longitudinal direction, between the inner surface of the first inner ring and the receiving surface of the second inner ring in line therewith is defined by

Eₚ=√((4*Sf*F_{preload})/(0.9*π*N*Re))+β, where

Eₚ corresponds to the distance, normal to the longitudinal direction, between the inner surface of the first inner ring and the receiving surface of the second inner ring in line therewith,

F_{preload} is the force by which the second inner ring is held in axial abutment against the first inner ring,

Re is the yield strength of the screw material,

N is the number of screws used to apply said force,

Sf is a safety parameter between 1.2 and 4,

β is a parameter between 4 and 5.

In one embodiment, the distance, normal to the longitudinal direction, between the inner surface of the first inner ring and the receiving surface of the second inner ring in line therewith is greater than 5 and is defined by

Eₚ=γ√((4*Sf*F_{preload})/(0.9*π*N*Re)), where

Eₚ corresponds to the distance, normal to the longitudinal direction, between the inner surface of the first inner ring and the receiving surface of the second inner ring in line therewith,

F_{preload} is the force by which the second inner ring is held in axial abutment against the first inner ring,

Re is the yield strength of the screw material,

N is the number of screws used to apply said force,

Sf is a safety parameter between 1.2 and 4,

γ is a weighting coefficient between 1 and 1.8.

In one embodiment, N is the nearest integer to or the integer immediately above

(π*d_{shaft})/(3.8*d_{screw}), where

d_{shaft} is the inside diameter of the first inner ring,

d_{screw} is the diameter of the screws.

In one embodiment, the rolling elements of the two rows of rolling elements have the same type of geometry.

In one embodiment, the rolling elements of the first row, proximal, of rolling elements are truncated cones arranged with the maximum diameter on the proximal side.

In one embodiment, the distance between the proximal first outer race and the shoulder for assembly to a housing is at least equal to δᵣ·dₘₐₓ, where δᵣ is a safety parameter between 1 and 1.5, and dₘₐₓ is the maximum diameter of the rolling elements of the first row, proximal, of rolling elements.

In one embodiment, the distance between the proximal first inner race and the shoulder for assembly to a blade root is at least equal to η₁ᵣ·(d_{shaft})^{n1r}, where η₁ᵣ is a parameter at least equal to 0.4, d_{shaft} denotes the inside diameter of the inner surface of the first inner ring, and n1r is a parameter between 0.4 and 0.5.

In one embodiment, the axis of the rolling elements of the first row, proximal, of rolling elements forms an angle of between 35° and 45° with the longitudinal direction, the minimum diameter of the truncated cone being closer to the axis than the maximum diameter.

In one embodiment, the rolling elements of the second row, distal, of rolling elements are truncated cones arranged with the maximum diameter on the distal side.

In one embodiment, the distance, measured in the longitudinal direction, between the proximal first outer race and the distal second outer race is between 0.4l*1 and l1, where l1 denotes the length of the rolling elements of the first row, proximal, of rolling elements.

In one embodiment, the distance between the distal second inner race and the inner surface of the second inner ring is at least equal to η₂ᵣ·(d_{shaft2})^{n2r}, where η₂ᵣ is a parameter at least equal to 0.4, d_{shaft2} denotes the inside diameter of the inner surface of the first inner ring, and n2r is a parameter between 0.4 and 0.5.

In one embodiment, the axis of the rolling elements of the second row, distal, of rolling elements forms an angle of between 17° and 23° with the longitudinal direction, the minimum diameter of the truncated cone being closer to the axis than the maximum diameter.

In one embodiment, the rolling elements of the first row, proximal, of rolling elements are ball bearings.

In one embodiment, the radial distance from the outer surface of the ball bearing of the first row, proximal, of rolling elements to the outer surface of the outer ring is at least equal to δ_{1eb}·φ₁, where δ_{1eb} a safety parameter greater than 0.45, and φ₁ is the diameter of the ball bearings of the first row, proximal, of rolling elements, and said distance is greater than 8 millimeters.

In one embodiment, the radial distance from the outer surface of the ball bearing of the first row, proximal, of rolling elements to the inner surface of the first inner ring is at least equal to δ_{1ib}·φ₁, where δ_{1ib} is a safety parameter greater than 0.45, and φ₁ is the diameter of the ball bearings of the first row, proximal, of rolling elements, and said distance is greater than 8 millimeters.

In one embodiment, the axis of the forces applied to the rolling elements of the first row, proximal, of rolling elements forms an angle of between 25° and 35° with the longitudinal direction.

In one embodiment, the rolling elements of the second row, distal, of rolling elements are ball bearings.

In one embodiment, the radial distance from the outer surface of the ball bearing of the second row, distal, of rolling elements to the outer surface of the outer ring is at least equal to δ_{2eb}·φ₂, where δ_{2eb} a safety parameter greater than 0.4, and φ₂ is the diameter of the ball bearings of the second row, distal, of rolling elements, and said distance is greater than 6 millimeters.

In one embodiment, the radial distance from the outer surface of the ball bearing of the second row, distal, of rolling elements to the inner surface of the second inner ring is at least equal to δ_{2eb}·φ₂, where δ_{2eb} a safety parameter greater than 0.4, and φ₂ is the diameter of the ball bearings of the second row, distal, of rolling elements, and said distance is greater than 6 millimeters.

In one embodiment, the distance, measured in the longitudinal direction, between the ball bearings of the first row of rolling elements and the ball bearings of the second row of rolling elements is greater than (φ1+φ2)/v, where φ1 denotes the diameter of the ball bearings of the first row of rolling elements, φ2 denotes the diameter of the ball bearings of the second row of rolling elements, and v is a parameter between 2 and 4.2.

In one embodiment, the axis of the forces applied to the rolling elements of the second row, distal, of rolling elements forms an angle of between 15° and 25° with the longitudinal direction.

In one embodiment, the height of the shoulder for assembly to the housing is defined so as to satisfy the following conditions:

10<φ1/2·He<25,

where θ1 corresponds to the outside diameter of the outer ring at the proximal first row of rolling elements.

According to another aspect, the invention relates to an oscillating system comprising such a rolling bearing, a housing assembled to the shoulder for assembly to a housing of the outer surface of the single outer ring, a blade comprising a blade root assembled to the shoulder for assembly to a blade root of the inner surface of the first inner ring, the blade being mounted so as to oscillate about said axis extending in the longitudinal direction relative to the housing by means of the rolling bearing.

According to another aspect, the invention relates to a system rotating about an axis of rotation, the system comprising at least one such oscillating system extending radially relative to the axis of rotation, the rolling bearing being distanced from the axis of rotation.

### BRIEF DESCRIPTION OF THE DRAWINGS

The drawings in the figures will now be briefly described.

FIG. 1 is a perspective schematic diagram of a rotor.

FIG. 2 is a sectional view of a first embodiment of a rolling bearing for a blade root.

FIG. 3 is a sectional view of a second embodiment of a rolling bearing for a blade root.

Below is a detailed description of several embodiments of the invention, accompanied with examples and with reference to the drawings.

### DETAILED DESCRIPTION OF THE INVENTION

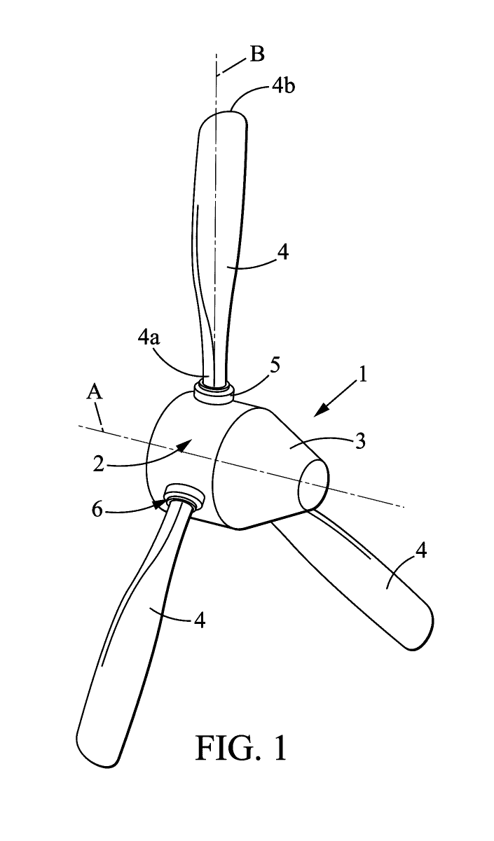

FIG. 1 schematically represents a three-dimensional perspective view of an example of a rotating system 1 according to an exemplary implementation of the invention. The rotating system 1 comprises a hub (not shown) of axis A about which is rotatably mounted a rotor 2. The rotor 2 rotates relative to the hub about the axis A. The rotor 2 comprises a main body 3, for example rotationally symmetrical about the axis A. The rotor 2 also comprises one or more blades 4 (in the example, three blades 4), each extending radially relative to the hub. Each blade 4 extends along a longitudinal axis B. As a blade may have a very complex shape, it is difficult to precisely define the longitudinal axis B, except that it corresponds to the main direction of the blade 4. Also, when describing the blade 4 as extending “radially”, this does not necessarily mean that the B axis intersects the A axis or extends in a plane perpendicular to the A axis, but that the general direction of the blade 4 tends toward a radial direction.

The blade 4 extends between one end, called the blade root 4a, where it is joined to the main body 3, and a free opposite end 4b. The blade 4 is mounted, at its root 4a, in a housing 5 fixed to the main body 3. The blade 4 is mounted so as to oscillate in the housing 5 by means of a rolling bearing (described in detail below) mounted between the blade root 4a and the housing 5. The rolling bearing in question has an axis of rotation, and the oscillation of the blade 4 relative to the housing 5 is allowed relative to this axis. The axis in question is clearly defined and extends substantially along the B axis. To better understand this concept, one can consider the B axis as corresponding to the axis of the rolling bearing, and therefore the axis of the rolling bearing will be referred to as B.

During operation, the blade 4 will rotate relative to the housing 5 about the B axis, but in principle along an angular path of less than 360°. On the other hand, the blade 4 will oscillate relative to the housing 5 about the B axis in controlled back-and-forth movements, according to the forces transmitted by the blade to the surrounding fluid (air).

The housing 5 is any component enabling this implementation.

As explained above, the rolling bearing is therefore eccentric with respect to the A axis, and is therefore subjected to strong centrifugation around the A axis during use of the rotating system 1.

The present invention is described in a specific context, but seems applicable to other contexts with a rolling bearing oscillating about a radial axis and spinning around an axial axis.

The assembly of the housing 5, the rolling bearing, and the blade root 4a is thus called an oscillating system 6.

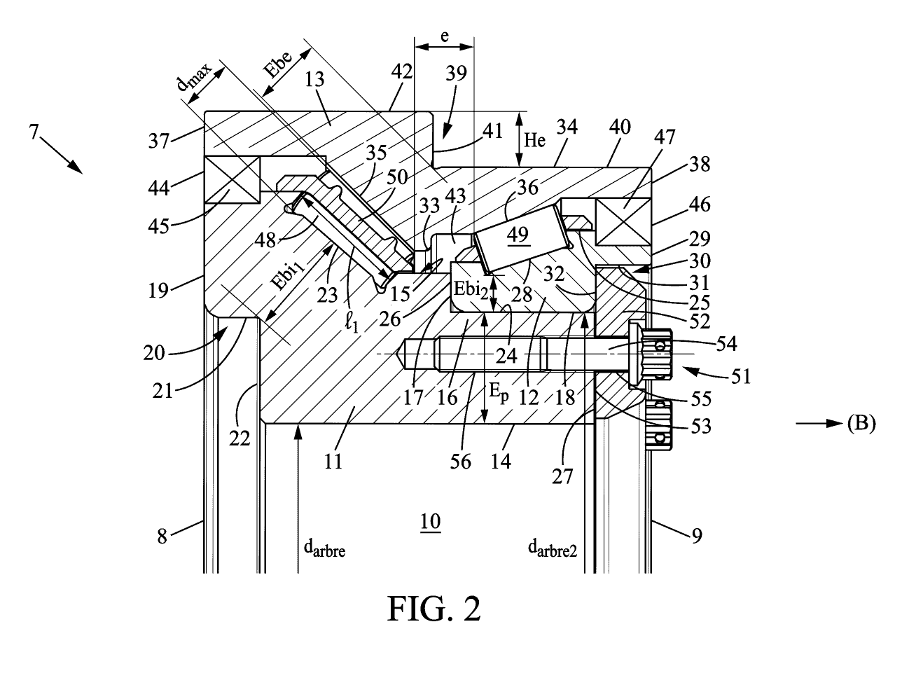

FIG. 2 represents a first embodiment of a rolling bearing according to the invention.

In the following, the term “axial” refers to the B axis of the rolling bearing 7, parallel to the direction represented (B). The term “proximal” refers to the proximity of a component to the A axis, while the term “distal” refers to a component being more distant from the A axis.

The rolling bearing 7 thus comprises a proximal side 8, and a distal side 9 opposite to the proximal side 8.

The rolling bearing 7 defines an interior bore 10 within which the blade root 4 is to be mounted.

In what follows, the term “inner” is used to denote proximity to the B axis, while the term “outer” is used to designate being more distant from the B axis.

The rolling bearing 7 comprises a first inner ring 11, a second inner ring 12, and a single outer ring 13. The inner rings 11 and 12 are so named because they each provide an inner race for rolling elements, and the outer ring 13 is so named because it provides outer races for rolling elements, as will be explained in more detail below.

The first inner ring 11 comprises an inner surface 14 and an outer surface 15 opposite to the inner surface 14. The inner surface 14 may have any suitable geometry. For example, the inner surface 14 may be composed of two rotationally symmetrical cylindrical surfaces each in line with a row of rolling elements, with an interposed groove in the center. The inner surface 14 is used for mounting the rolling bearing 7 on the blade root. The inner surface 14 has a minimum diameter d_{shaft}. The first inner ring 11 extends axially from the proximal end 8 toward the distal end 9, along a large majority of the axial length of the rolling bearing 7.

In the distal half of the rolling bearing 7, the outer surface 15 of the first inner ring 11 defines a distal seat 16 for receiving the second inner ring 12. The distal seat 16 comprises an axial abutment surface 17 facing the distal side 9, and a cylindrical receiving surface 18 facing outwardly and extending from the axial abutment surface 17.

In the proximal half of the rolling bearing 7, the outer surface 15 defines a proximal first race 23.

The first inner ring 11 has a proximal end surface 19. The inner surface 14 of the first inner ring 11 comprises a shoulder 20 for assembly to a blade root. The shoulder 20 comprises a cylindrical surface 21 extending from the proximal end surface 19 towards the distal end, an axial abutment surface 22 facing the proximal end 8 and extending from the cylindrical surface 21 to the bore 10.

The first inner ring 11 has a distal end surface 27, opposite to the axial abutment surface 22 and facing the distal side 9.

The second inner ring 12 comprises an inner surface 24 and an outer surface 25 opposite to the inner surface 24. The inner surface 24 is used for assembly by fitting the second inner ring 12 into the seat 16 of the first inner ring. The inner surface 24 has a minimum diameter d_{shaft2}. The inner surface 24 therefore faces, while being complementary to, the cylindrical receiving surface 18. The second inner ring 12 extends axially from a first axial abutment surface 26 facing the proximal end 8 towards the distal side 9, for about the distal half of the axial length of the rolling bearing 7.

The outer surface 25 defines a second distal race 28.

The second inner ring 12 has a distal end surface 29. The inner surface 24 of the second inner ring 11 comprises a shoulder 30 for preloading. The shoulder 30 comprises a cylindrical surface 31 extending from the distal end surface 29 towards the proximal end, an axial abutment surface 32 facing the distal end 9 and extending from the cylindrical surface 31 to the cylindrical receiving surface 18.

The outer ring 13 comprises an inner surface 33 and an outer surface 34 opposite to the inner surface 33. The outer surface 34 is used for mounting the rolling bearing 7 on the housing. The outer ring 13 extends axially from the proximal side 8 to the distal side 9, along the entire axial length of the rolling bearing 7.

In the proximal half of the rolling bearing 7, the inner surface 33 defines a proximal second race 35. In the distal half of the rolling bearing 7, the inner surface 33 defines a distal second race 36.

The outer ring 11 has a proximal end surface 37 and an opposite distal end surface 38. The outer surface 34 comprises a shoulder 39 for assembly to the housing. The shoulder 39 comprises a cylindrical surface 40 extending from the distal end surface 38 towards the proximal end, an axial abutment surface 41 facing the distal side 9 and extending from the cylindrical surface 40 to a second cylindrical surface 42. The second cylindrical surface 42 extends from the axial abutment surface 41 to the proximal end surface 37.

A single inner space 43 is defined between the inner surface 33 of the outer ring 13 and the outer surface 15, 25 of the first and second inner rings 11, 12, the single inner space 43 extending between a proximal end 44 where it is sealed by a proximal sealing system 45 between the outer ring 13 and the first inner ring 11, and a distal end 46 where it is sealed by a distal sealing system 47 between the outer ring 13 and the second inner ring 12.

In the single inner space 43, the proximal first outer and inner races 23, 35 face each other, and the distal second outer and inner races 28, 36 face each other.

A proximal first row of rolling elements 48 is mounted in the single inner space, rolling on the proximal first outer and inner races 23, 35. A distal second row of rolling elements 49 is mounted in the single inner space, rolling on the distal second outer and inner races 28, 36. The first and second rows of rolling elements 48, 49 are spaced apart from each other along the longitudinal axis B.

Where appropriate, the rolling elements of a same row are spaced apart from each other by a cage 50, as represented in FIG. 2 for the proximal row.

The rolling bearing 7 comprises a loading system 51 adapted to hold the second inner ring 12 in axial abutment against the first inner ring 11.

The loading system 51 comprises an annular plate 52 having a bearing surface 53 in contact with the second inner ring 12 and urging the second inner ring 12 in the axial direction, the annular plate 52 being kept secured to the first inner ring 11 by screws 54. More specifically, the plate 52 is screwed onto the inner ring 51 by screws passing through bores 55 of the plate 52 and bores 56 of the first inner ring 11 that are placed in alignment with bores 55. The bearing surface 53 presses on the axial abutment surface 32, thereby urging the second inner ring 12 toward the proximal side, these clamping forces being applied at the contact between the axial abutment surface 17 of the first inner ring 11 and the axial abutment surface 26 of the second inner ring 12. The screws are tightened until a loading force F_{preload} is applied.

The conditions described below appear favorable for allowing a rolling bearing of reduced mass to function in a smaller footprint. Depending on the application, the footprint (particularly the axial dimension, meaning along the axis of the rolling bearing), the mass, and the required performance level may vary. However, a rolling bearing having one or more of the following specific features is considered advantageous for addressing these issues.

The distance Eₚ, normal to the longitudinal direction B, between the inner surface 14 of the first inner ring 11 and the receiving surface 18 of the second inner ring 12 in line therewith can be defined by

Eₚ=√((4*Sf*F_{preload})/(0.9*π*N*Re))+β, where

Eₚ corresponds to the distance, normal to the longitudinal direction, between the inner surface of the first inner ring and the inner surface of the second inner ring in line therewith,

F_{preload} is the force by which the second inner ring 12 is held in axial abutment against the first inner ring 11,

Re is the yield strength of the screw material,

N is the number of screws used to apply the preload force,

Sf is an application-dependent safety parameter, between 1.2 and 4,

β is a parameter of between 4 and 5.

In particular, N may be chosen as the nearest integer to or the integer immediately above (π*d_{shaft})/(3.8*d_{screw}), where d_{screw} is the diameter of the screws.

This definition ensures the application of sufficient preload force without damaging the rolling bearing, and with a limited footprint.

The above definition can be applied in particular to the case of smaller bearings, where the size of the screw head has an impact.

Alternatively, the distance Eₚ, normal to the longitudinal direction B, between the inner surface 14 of the first inner ring 11 and the receiving surface 18 of the second inner ring 12 in line therewith may be both greater than 5 millimeters (mm) and be defined by

Eₚ=γ√/((4*Sf*F_{preload})/(0.9*Tr*N*Re)), where

Eₚ corresponds to the distance, normal to the longitudinal direction, between the inner surface of the first inner ring and the inner surface of the second inner ring in line therewith,

F_{preload} is the force by which the second inner ring is held in axial abutment against the first inner ring,

Re is the yield strength of the screw material,

N is the number of screws used to apply the preload force,

Sf is an application-dependent safety parameter, between 1.2 and 4,

γ is a weighting coefficient between 1 and 1.8.

In particular, N may be chosen as the nearest integer to or the integer immediately above (π*d_{shaft})/(3.8*d_{screw}), where d_{screw} is the diameter of the screws.

The above definition can be applied in particular to the case of large bearings, where the size of the screw head has no impact.

The shoulder 39 for assembly to the housing, in particular the axial abutment surface 41 thereof, provided on the outer surface 34 of the single outer ring 13, is arranged axially (along direction (B)) between the first and second rows of rolling elements, in other words substantially at the center, axially, of the length of the rolling bearing 7. The shoulder 20 for assembly to the blade root, provided on the inner surface 14 of the first inner ring 12, is more proximal than the proximal first row 48 of rolling elements.

Thus, the axial forces applied to the bearing are essentially supported by the proximal first row 48 of rolling elements. An asymmetrical rolling bearing is thus provided, the distal second row of rolling elements not being sized to support the axial forces applied to the rolling bearing as much as the proximal first row of rolling elements.

The height He of the shoulder for assembly to the housing, in other words the axial abutment surface 41, is defined so as to satisfy the following conditions:

10<φ1/2·He<25,

where θ1 corresponds to the outside diameter of the outer ring 13 at the first row 48, proximal, of rolling elements.

In the example presented above, the rolling elements of the first row, proximal, of rolling elements are truncated cones arranged with the maximum diameter dₘₐₓ on the proximal side. The axis of the rolling elements of the first row, proximal, of rolling elements forms an angle of between 35° and 45° with the longitudinal direction (B), the minimum diameter of the truncated cone being closer to the B axis than the maximum diameter. Thus, the axis of the rolling elements 48 is substantially orthogonal to the axis of the forces applied between axial abutment surface 22 and axial abutment surface 41. This configuration provides a high level of axial load transfer between the blade and the housing.

The distance (Ebe) between the proximal first outer race 35 and the shoulder 41 for assembly to a housing, measured perpendicularly to the proximal first outer race 35, is at least equal to δᵣ·dₘₐₓ, where δᵣ is a safety parameter between 1 and 1.5, and dₘₐₓ is the maximum diameter of the rolling elements of the first row, proximal, of rolling elements. This design ensures transmission of axial forces between the rolling elements and the housing, with little risk of damaging the rolling bearing and with a small footprint.

The distance (Ebi1) between the proximal first inner race 23 and the shoulder 20 for assembly to a blade root, measured perpendicularly to the proximal first inner race 23, is at least equal to η₁ᵣ·(d_{shaft})^{η1r}, where η₁ᵣ is a parameter at least equal to 0.4, d_{shaft} denotes the inside diameter of the inner surface 14 of the first inner ring 12, and n1r is a parameter between 0.4 and 0.5. This design ensures transmission of axial forces between the blade and the rolling elements, with little risk of damaging the bearing and with a small footprint.

According to this embodiment, the rolling elements 49 of the second row, distal, of rolling elements are truncated cones arranged with the maximum diameter on the distal side. The axis of the rolling elements 49 of the second row, distal, of rolling elements forms an angle of between 17° and 23° with the longitudinal direction (B), the minimum diameter of the truncated cone being closer to the B axis than the maximum diameter.

The distance (Ebi2) between the distal second inner race 28 and the distal seat 16 of the outer surface 15 of the first inner ring 12, measured perpendicularly to the distal seat 16, is at least equal to η₂ᵣ·(d_{shaft2})^{n2r}, where η₂ᵣ is a parameter at least equal to 0.4, d_{shaft2} denotes the inside diameter of the inner surface 24 of the second inner ring, and n2r is a parameter between 0.4 and 0.5. This geometry ensures sufficient transmission of forces but with a small footprint.

Where appropriate, η₁ᵣ=η₂ᵣ.

Where appropriate, n1r=n2r.

The distance e, measured in the longitudinal direction (B) between the proximal first outer race 35 and the distal second outer race 36, is between 0.4*l1 and l1 where l1 is the length of the rolling elements 48 of the first row, proximal, of rolling elements. With this arrangement, the axial compactness of the rolling bearing is maintained, and the rolling bearing 7 supports significant bending moments during use.

In the example above, the rolling elements of the two rows of rolling elements have the same type of geometry.

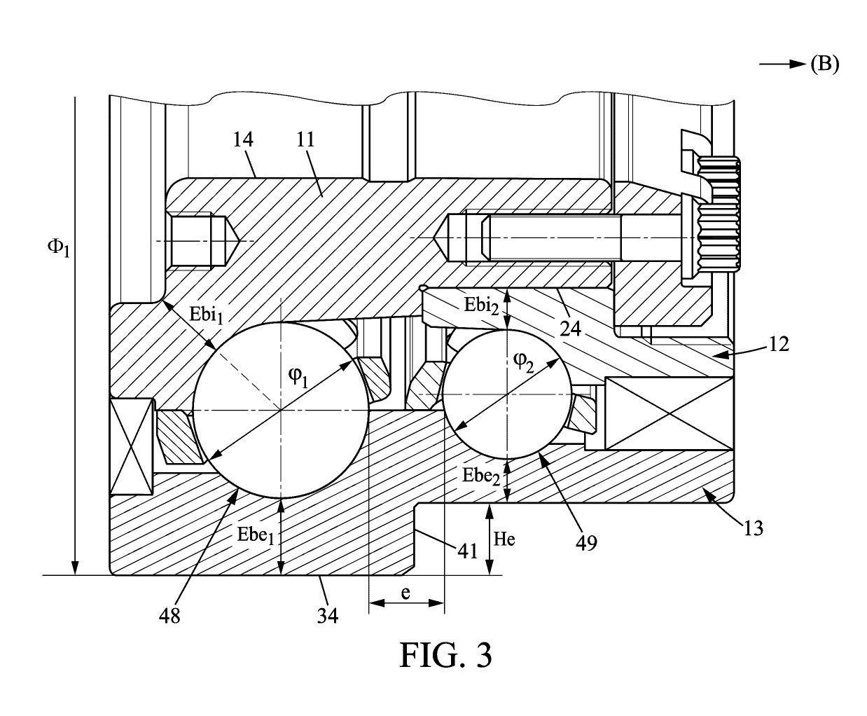

According to a second embodiment, as represented in FIG. 3, the rolling elements of the proximal first row 48 of rolling elements are ball bearings of diameter φ1. The axis of the forces applied to the rolling elements of the first row 48, proximal, of rolling elements forms an angle of between 25° and 35° with the longitudinal direction.

The radial distance (Ebe1) from the outer surface of the ball bearing of the first row 48, proximal, of rolling elements to the outer surface 34 of the outer ring 13 is at least equal to δ_{1eb}·φ₁, where δ_{1eb} is a safety parameter greater than 0.45, and φ₁ is the diameter of the ball bearings of the first row 48, proximal, of rolling elements. The distance Ebi1 is greater than 8 millimeters (mm).

The radial distance (Ebi1) from the outer surface of the ball bearing of the first row 48, proximal, of rolling elements to the inner surface 14 of the first inner ring 11 is at least equal to δ_{1ib}φ₁, where δ_{1ib} is a safety parameter greater than 0.45, and φ₁ is the diameter of the ball bearings of the first row 48, proximal, of rolling elements. The distance Ebi1 is greater than 8 millimeters (mm).

Where appropriate, δ_{1ib}=δ_{1eb}.

According to this embodiment, the rolling elements of the second row 49, distal, of rolling elements are ball bearings, of diameter φ2. The axis of the forces applied to the rolling elements of the second row 49, distal, of rolling elements forms an angle of between 15° and 25° with the longitudinal direction.

The radial distance (Ebe2) from the outer surface of the ball bearing of the second row 49, distal, of rolling elements and the outer surface 34 of the outer ring 13 is at least equal to δ_{2eb}·φ₂, where δ_{2eb} a safety parameter greater than 0.4, and φ₂ is the diameter of the ball bearings of the second row 49, distal, of rolling elements, and where said distance (Ebe2) is greater than 6 millimeters (mm). This geometry ensures sufficient transmission of forces but with a small footprint.

The radial distance (Ebi2) from the outer surface of the ball bearing of the second row 49, distal, of rolling elements and the inner surface 24 of the second inner ring 12 is at least equal to δ_{2ib}·φ₂, where δ_{2ib} is a safety parameter greater than 0.4, and φ₂ is the diameter of the ball bearings of the second row 49, distal, of rolling elements, and where said distance (Ebi2) is greater than 6 millimeters (mm).

Where appropriate, δ_{2ib}=δ_{2eb}.

The distance (e), measured on the outer ring 13 in the longitudinal direction (B), between the ball bearings of the first row 48 of rolling elements and the ball bearings of the second row 49 of rolling elements is greater than (φ1+φ2)/v, where φ1 denotes the diameter of the ball bearings of the first row 48 of rolling elements, φ2 denotes the diameter of the ball bearings of the second row 49 of rolling elements, and v is a parameter between 2 and 4.2.

1. Rolling bearing for a blade root extending in a longitudinal direction between a proximal end and a distal end, the rolling bearing allowing oscillation of the root about an axis extending in the longitudinal direction relative to a housing,
the rolling bearing comprising:
a single outer ring having an inner surface and an outer surface opposite to the inner surface, the inner surface of the outer ring having a proximal first outer race and a distal second outer race, the first and second outer races being offset relative to one another in the longitudinal direction,
a first inner ring having an inner surface and an outer surface opposite to the inner surface, the outer surface of the first inner ring having a proximal first inner race and a distal seat, the first inner race and the seat being offset relative to one another in the longitudinal direction,
a second inner ring having an inner surface and an outer surface opposite to the inner surface, the outer surface of the second inner ring having a distal second inner race, the second inner ring being fitted onto the seat and being held in axial abutment against the first inner ring,
a single inner space being defined between the inner surface of the outer ring and the outer surface of the first and second inner rings, the single inner space extending between a proximal end where it is sealed by a proximal sealing system between the outer ring and the first inner ring and a distal end where it is sealed by a distal sealing system between the outer ring and the second inner ring,
a proximal first row of rolling elements mounted in the single inner space, rolling on the proximal first inner and outer races, and a distal second row of rolling elements mounted in the single inner space, rolling on the distal second outer and inner races, the first and second rows of rolling elements being spaced apart from each other along the longitudinal axis,
the inner surface of the first inner ring comprising a shoulder for assembly to a blade root,
the outer surface of the single outer ring comprising a shoulder for assembly to a housing.

2. Rolling bearing for a blade root according to claim 1, further comprising one and/or the other of the following arrangements:
the shoulder for assembly provided on the outer surface of the single outer ring is arranged axially between the first and second rows of rolling elements;
the shoulder for assembly provided on the inner surface of the first inner ring is arranged more proximally than the proximal first row of rolling elements.

3. Rolling bearing for a blade root according to claim 1, further comprising a loading system adapted to hold the second inner ring in axial abutment against the first inner ring;
and optionally wherein the loading system comprises an annular plate having a bearing surface in contact with the second inner ring and urging the second inner ring in the axial direction, the annular plate being held secured to the first inner ring by screwing.

4. Rolling bearing for a blade root according to claim 1, wherein the distance, normal to the longitudinal direction, between the inner surface of the first inner ring and the receiving surface of the second inner ring in line therewith is defined by
Eₚ=√((4*Sf*F_{preload})/(0.9*π*N*Re))+β, where
Eₚ corresponds to the distance, normal to the longitudinal direction, between the inner surface of the first inner ring and the receiving surface of the second inner ring in line therewith,
F_{preload} is the force by which the second inner ring is held in axial abutment against the first inner ring,
Re is the yield strength of the screw material,
N is the number of screws used to apply said force,
Sf is a safety parameter between 1.2 and 4,
β is a parameter between 4 and 5;
or wherein the distance, normal to the longitudinal direction, between the inner surface of the first inner ring and the receiving surface of the second inner ring in line therewith is greater than 5 and is defined by
Eₚ=γ√((4*Sf*F_{preload})/(0.9*π*N*Re)), where
Eₚ corresponds to the distance, normal to the longitudinal direction, between the inner surface of the first inner ring and the receiving surface of the second inner ring in line therewith,
F_{preload} is the force by which the second inner ring is held in axial abutment against the first inner ring,
Re is the yield strength of the screw material,
N is the number of screws used to apply said force,
Sf is a safety parameter between 1.2 and 4,
γ is a weighting coefficient between 1 and 1.8;
wherein, optionally, N is the nearest integer to or the integer immediately above
(π*d_{shaft})/(3.8*d_{screw}), where
d_{shaft} is the inside diameter of the first inner ring,
d_{screw} is the diameter of the screws.

5. Rolling bearing for a blade root according to claim 1, wherein the rolling elements of the two rows of rolling elements have the same type of geometry.

6. Rolling bearing for a blade root according to claim 1, wherein the rolling elements of the first row, proximal, of rolling elements are truncated cones arranged with the maximum diameter on the proximal side.

7. Rolling bearing for a blade root according to claim 6, further comprising the following characteristics:
the distance between the proximal first outer race and the shoulder for assembly to a housing is at least equal to δᵣ·dₘₐₓ, where δᵣ is a safety parameter between 1 and 1.5, and dₘₐₓ is the maximum diameter of the rolling elements of the first row, proximal, of rolling elements;
the distance between the proximal first inner race and the shoulder for assembly to a blade root is at least equal to η₁ᵣ·(d_{shaft})^{n1r}, where η₁ᵣ is a parameter at least equal to 0.4, d_{shaft} denotes the inside diameter of the inner surface of the first inner ring, and n1r is a parameter between 0.4 and 0.5;
the axis of the rolling elements of the first row, proximal, of rolling elements forms an angle of between 35° and 45° with the longitudinal direction, the minimum diameter of the truncated cone being closer to the axis than the maximum diameter.

8. Rolling bearing for a blade root according to claim 1, wherein the rolling elements of the second row, distal, of rolling elements are truncated cones arranged with the maximum diameter on the distal side.

9. Rolling bearing for a blade root according to claim 6, wherein the rolling elements of the second row, distal, of rolling elements are truncated cones arranged with the maximum diameter on the distal side and wherein the distance, measured in the longitudinal direction, between the proximal first outer race and the distal second outer race is between 0.4*l1 and l1, where l1 denotes the length of the rolling elements of the first row, proximal, of rolling elements.

10. Rolling bearing for a blade root according to claim 8, further comprising one and/or the other of the following characteristics:
the distance between the distal second inner race and the inner surface of the second inner ring is at least equal to η₂ᵣ·(d_{shaft2})^{n2r}, where η₂ᵣ is a parameter at least equal to 0.4, d_{shaft2} denotes the inside diameter of the inner surface of the first inner ring, and n2r is a parameter between 0.4 and 0.5;
the axis of the rolling elements of the second row, distal, of rolling elements forms an angle of between 17° and 23° with the longitudinal direction, the minimum diameter of the truncated cone being closer to the axis than the maximum diameter.

11. Rolling bearing for a blade root according to claim 1, wherein the rolling elements of the first row, proximal, of rolling elements are ball bearings,
and optionally further comprising one or more of the following characteristics:
the radial distance from the outer surface of the ball bearing of the first row, proximal, of rolling elements to the outer surface of the outer ring is at least equal to δ_{1eb}·φ₁, where δ_{1eb} is a safety parameter greater than 0.45, and φ₁ is the diameter of the ball bearings of the first row, proximal, of rolling elements, and said distance is greater than 8 millimeters;
the radial distance from the outer surface of the ball bearing of the first row, proximal, of rolling elements to the inner surface of the first inner ring is at least equal to δ_{1ib}·φ₁, where δ_{1ib} is a safety parameter greater than 0.45, and φ₁ is the diameter of the ball bearings of the first row, proximal, of rolling elements, and said distance is greater than 8 millimeters;
the axis of the forces applied to the rolling elements of the first row, proximal, of rolling elements forms an angle of between 25° and 35° with the longitudinal direction.

12. Rolling bearing for a blade root according to claim 1, wherein the rolling elements of the second row, distal, of rolling elements are ball bearings,
and optionally further comprising one or more of the following characteristics:
the radial distance from the outer surface of the ball bearing of the second row, distal, of rolling elements to the outer surface of the outer ring is at least equal to δ_{2eb}·φ₂, where δ_{2eb} is a safety parameter greater than 0.4, and φ₂ is the diameter of the ball bearings of the second row, distal, of rolling elements, and said distance is greater than 6 millimeters;
the radial distance from the outer surface of the ball bearing of the second row, distal, of rolling elements to the inner surface of the second inner ring is at least equal to δ_{2eb}·φ₂, where δ_{2eb} is a safety parameter greater than 0.4, and φ₂ is the diameter of the ball bearings of the second row, distal, of rolling elements, and said distance is greater than 6 millimeters;
the axis of the forces applied to the rolling elements of the second row, distal, of rolling elements forms an angle of between 15° and 25° with the longitudinal direction.

13. Rolling bearing for a blade root according to claim 11, wherein the rolling elements of the second row, distal, of rolling elements are ball bearings, and the distance, measured in the longitudinal direction, between the ball bearings of the first row of rolling elements and the ball bearings of the second row of rolling elements is greater than (φ1+φ2)/v, where φ1 denotes the diameter of the ball bearings of the first row of rolling elements, φ2 denotes the diameter the ball bearings of the second row of rolling elements, and v is a parameter between 2 and 4.2.

14. Rolling bearing for a blade root according to claim 1, wherein the height of the shoulder for assembly to the housing is defined so as to satisfy the following conditions:
10<φ1/2·He<25,
where φ1 corresponds to the outside diameter of the outer ring at the proximal first row of rolling elements.

15. Oscillating system comprising a rolling bearing according to claim 1, a housing assembled to the shoulder for assembly to a housing of the outer surface of the single outer ring, a blade comprising a blade root assembled to the shoulder for assembly to a blade root of the inner surface of the first inner ring, the blade being mounted so as to oscillate about said axis extending in the longitudinal direction relative to the housing by means of the rolling bearing.

16. System rotating about an axis of rotation, the system comprising at least one oscillating system according to claim 15 extending radially relative to the axis of rotation, the rolling bearing being distanced from the axis of rotation.
